(19) United States
(12) Patent Application Publication
(10) Pub. No.: US 2013/0030755 A1
(43) Pub. Date: Jan. 31, 2013

(54) METHOD FOR DETERMINING INFORMATION REPRESENTATIVE OF THE POSITION OF A REAL TOOTH ON A TOOTHED TARGET RIGIDLY ATTACHED IN ROTATION TO A SHAFT OF AN INTERNAL COMBUSTION ENGINE AND ASSOCIATED DEVICE

(71) Applicants: Pierre ZOUBOFF, Toulouse (FR); Jérôme LACHAIZE, Toulouse (FR)

(72) Inventors: Pierre ZOUBOFF, Toulouse (FR); Jérôme LACHAIZE, Toulouse (FR)

(73) Assignees: CONTINENTAL AUTOMOTIVE GMBH, Hannover (DE); CONTINENTAL AUTOMOTIVE FRANCE, Toulouse (FR)

(21) Appl. No.: 13/555,568

(22) Filed: Jul. 23, 2012

(30) Foreign Application Priority Data
Jul. 28, 2011 (FR) 1102362

(51) Int. Cl. G06F 15/00

(52) U.S. Cl. 702/151

(57) ABSTRACT

A method an device for determining information representative of the position of a real tooth of a toothed target rigidly attached in rotation to a shaft of an internal combustion engine, the toothed target including n real teeth and m missing teeth forming a reference area and the engine being equipped with a sensor for detecting the passage of the real teeth of the toothed target in front of the sensor and with a unit capable of measuring, for each tooth k, the period of time, called period (T(k)) of the tooth k, separating the tooth k from the preceding tooth k−1. For the tooth k, the following ratio is calculated:

$${R}^{′} ( k ) = [ \frac{{( T ( k - \frac{N}{2} ) )}^{N}}{{\prod }_{i}^{\frac{N}{2} + 1 … N} T ( k - i ) \times {\prod }_{i}^{0 … \frac{N}{2} - 1} T ( k - i )} ]$$

where N is an even integer greater than or equal to 2. Subsequently, based on this ratio, an information representative of the position of the tooth k with respect to the reference area is determined.

The invention relates, generally speaking, to the field of internal combustion engines equipped with a crankshaft having a toothed target comprising n real teeth and a reference area or long tooth made up of m missing teeth.

In order to determine the position of an internal combustion engine, conventionally, an engine control unit or ECU, a toothed target and a detection sensor are used. The target is a wheel, generally mounted onto the crankshaft of the engine and rigidly attached to the latter, conventionally comprising 36 or 60 teeth distributed around its periphery at regular angular intervals, each tooth then corresponding to an angular rotation of 10 or 6 degrees of the crankshaft. The target also comprises a reference area commonly referred to as “long tooth” characterized by the absence of m teeth, m usually being in the range between 1 and 3. This reference area is employed for counting the complete rotations of the crankshaft and synchronizing the engine management systems.

By detecting the passage of the various teeth of the target in front of the sensor, the angular position of the crankshaft and its instantaneous speed of rotation may be determined, said information subsequently notably being used for the control of fuel injection into the cylinders of the engine or spark plug timing.

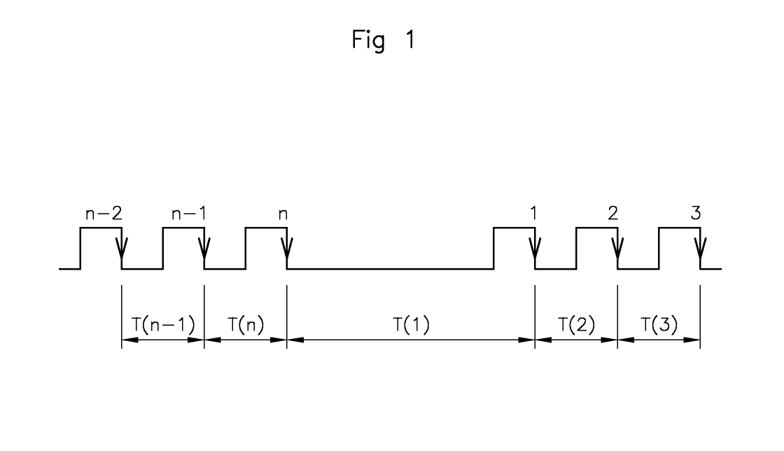

The sensor yields a result in the form of a pulsed signal such as shown in FIG. 1: when it sees one of the n real teeth of the target, the sensor produces a pulse and, when the reference area passes, the sensor produces an inactive signal equal to zero. In the example in FIG. 1, the pulsed signal relates to a toothed target comprising m=2 missing teeth.

At each falling edge (but the same operational logic may be applied to each rising edge) of the pulsed signal, a counter is incremented in the ECU for counting the teeth detected by the sensor and deducing from this the angular position of the crankshaft. The angular position of the crankshaft is defined by the number of teeth counted starting from the reference area. The reference area is itself detected by measuring the period of time passing between two successive real teeth.

The instantaneous angular position of the crankshaft is thus determined by calculating the difference between the instantaneous value of the counter and the value of the counter at the moment of the detection of the last reference area. The angular position of the crankshaft is then the angular value corresponding to this difference.

It sometimes happens that a tooth of the toothed target is not detected by the sensor for various reasons. These reasons are generally electrical in origin (interference, bad contact, etc.) or mechanical (variation of the toothed wheel-sensor distance, vibration, etc.). For these same reasons, it sometimes happens that the sensor detects a tooth which, in reality, does not exist. If a tooth is not detected or is detected as an extra one, the relation between the value of the counter and the angular position of the crankshaft is no longer valid since the value of the counter is no longer representative of the position of the tooth on the toothed target.

In the following part of the description, n denotes the initial number of teeth on the toothed target, m denotes the number of missing teeth in the reference area, r(k) denotes the rank of the tooth k with respect to the reference area and T(k) represents the period of time separating the detection of the tooth k from the detection of the tooth k−1.

In order to deal with the non-detection or the erroneous detection of a spurious tooth, a known solution is to verify the position or the rank of each tooth k, after detection of the latter, by calculating the ratio

$$R ( k ) = \frac{T ( k )}{T ( k - 1 )} .$$

If the ratio R(k) is close to (m+1), the rank r(k) of the tooth k is equal to 1. If it is close to [1/(m+1)], the rank r(k) is equal to 2. Finally, if it is close to 1, the rank r(k) is in the range between 3 and n.

In the case of a toothed target comprising m=2 missing teeth, this gives:

if R(k) is close to 3 (m+1=3 here), then r(k)=1;

if R(k) is close to

$$\frac{1}{3} ( \frac{1}{m + 1} = \frac{1}{3} here ) ,$$

then r(k)=2; and

if R(k) is close to 1, then r(k) is in the range between 3 and n.

This method allows the position of a tooth k on the toothed target to be determined with respect to the reference area (in the following part of the description, the term position of the tooth k or rank of the tooth k will be used interchangeably). This method also allows it to be detected whether a tooth is missing or not. If R(k) is substantially equal to 2, this means that the tooth of rank r(k−1) has not been detected. If R(k)=4, this means that the tooth of rank 1 has not been detected.

More generally speaking, this method therefore allows the plausibility of the rank of a tooth to be verified even if, beforehand, a tooth has not been detected or if an extra spurious tooth has been detected by the sensor, which would have the result of shifting the position of the reference area obtained by counting with respect to its real position.

This method is not however robust in certain situations, notably when the engine speed varies abruptly going, for example, from an acceleration phase to a deceleration phase or vice versa. For example, if the passage of the acceleration phase to the deceleration phase occurs between the detection of the tooth of rank 2 and the detection of the tooth of rank 3, the discrimination between these two teeth can be very difficult because R(2) is very close to R(3).

Furthermore, even without going from an acceleration phase to a deceleration phase or vice versa, if it is considered that the sensor may miss a real tooth or add a spurious tooth, this method does not allow an acceleration during the reference area to be clearly differentiated from a deceleration just before this area.

One aim of the present invention is to provide a more robust method for determining the position of the teeth of the toothed target, notably in the case of an abrupt change of engine speed.

One subject of the invention is a method for determining information representative of the position of a real tooth of a toothed target rigidly attached in rotation to a shaft of an internal combustion engine, the toothed target comprising n real teeth and m missing teeth forming a reference area and said engine being equipped with a sensor for detecting the passage of the real teeth of the toothed target in front of said sensor and with a unit capable of measuring, for each tooth k, the time, called period T(k) of the tooth k, separating said tooth k from the preceding tooth k−1, said method being noteworthy in that it comprises the following steps:
a) a first product is calculated by multiplying N times the period

$$( T ( k - \frac{N}{2} ) )$$

of the tooth

$$k - \frac{N}{2} ,$$

N being an even integer greater than or equal to 2,
b) a second product is calculated by multiplying together the periods (T(k−i)) of the teeth i, with i in the range between 0 and

$$\frac{N}{2} - 1$$

and between

$$\frac{N}{2} + 1$$

### and N,

c) the ratio between the first product and the second product, denoted R′(k), is calculated and
d) based on the ratio R′(k), an information representative of the position of the tooth k with respect to the reference area is determined.

The ratio R′(k) may also be expressed in the following manner:

$${R}^{′} ( k ) = [ \frac{{( T ( k - \frac{N}{2} ) )}^{N}}{{\prod }_{i}^{\frac{N}{2} + 1 … N} T ( k - i ) \times {\prod }_{i}^{0 … \frac{N}{2} - 1} T ( k - i )} ]$$

Information representative of the position of the tooth k is deduced from this ratio.

According to one particular embodiment, the position of the tooth k is determined in the following manner:
if the ratio R′(k) is close to (m+1)^{N}, the tooth k is the tooth of rank j with j=p+1 and p being such that N=2^{p};
if the ratio R′(k) is close to

$$\frac{1}{m + 1} ,$$

the tooth k is a tooth of rank j, with jε[1, p]∪[p+2, N+1]; and
if the ratio R′(k) is close to 1, the tooth k is a tooth of rank j, with jε[N+2, n].

Advantageously, with each of the values

$$\frac{1}{m + 1} ,$$

1 and (m+1)^{N} is associated an interval encompassing said value, said intervals being non-mutually overlapping.

Thus, if the ratio R′(k) is included within the interval defined for the value (m+1)^{N}, then the tooth k is the tooth of rank j with j=p+1 and N=2^{p}. If the ratio R′(k) is included within the interval defined for the value

$$\frac{1}{m + 1} ,$$

then the tooth k is a tooth of rank j, with jε[1, p]∪[p+2, N+1]. Finally, if the ratio R′(k) is included within the interval defined for the value 1, then the tooth k is a tooth of rank j, with jε[N+2, n].

According to one particular embodiment, said intervals are centered on the values

$$\frac{1}{m + 1} ,$$

1 and (m+1)^{N}.

The intervals are for example:

[(1−ε)(m+1)²,(1+ε)(mα1)²] for the value (m+1)²,

$$[ \frac{1 - ɛ}{m + 1} , \frac{1 + ɛ}{m + 1} ]$$

for the value

$$\frac{1}{m + 1} ,$$

and

[1−ε,1+ε] for the value 1,
with ε in the range between 0.01 and 0.5.

The invention also relates to the device implementing the method previously described and comprising means for calculating the first product and the second product, together with the ratio R′(k) between the first product and the second product, and means for determining information representative of the position of the tooth k with respect to the reference area based on the ratio R′(k).

The invention will be better understood, and other objectives, details, features and advantages will become more clearly apparent during the detailed description that follows, with reference hereinafter to the appended drawings, amongst which:

FIG. 1 is a timing diagram for a pulsed signal supplied by a sensor for detecting real teeth of the toothed target;

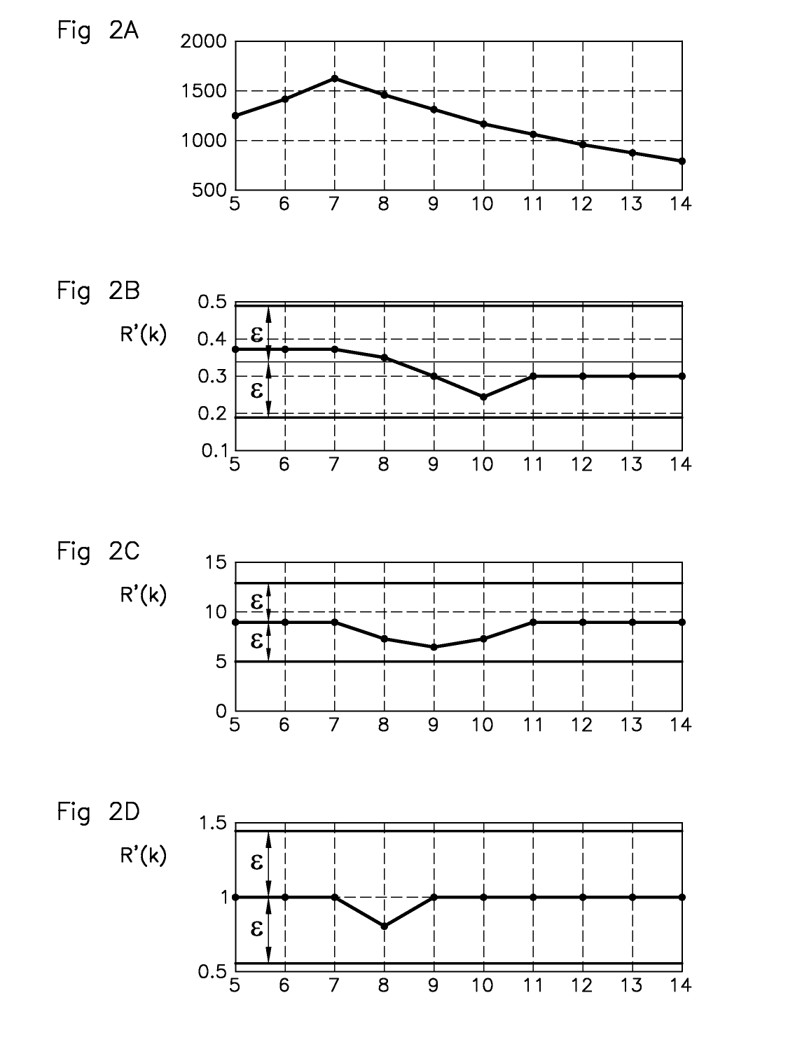

FIG. 2A is a curve illustrating a first profile of variation of the engine speed (in revs/minute) over time as the teeth k are detected;

FIG. 2B is a curve representing the value of the ratio R′(k) calculated for each of the teeth k in FIG. 2A when said teeth k are teeth of rank 1;

FIG. 2C is a curve representing the value of the ratio R′(k) calculated for each of the teeth k in FIG. 2A when said teeth k are teeth of rank 2;

FIG. 2D is a curve representing the value of the ratio R′(k) calculated for each of the teeth k in FIG. 2A when said teeth k are teeth of rank greater than 3;

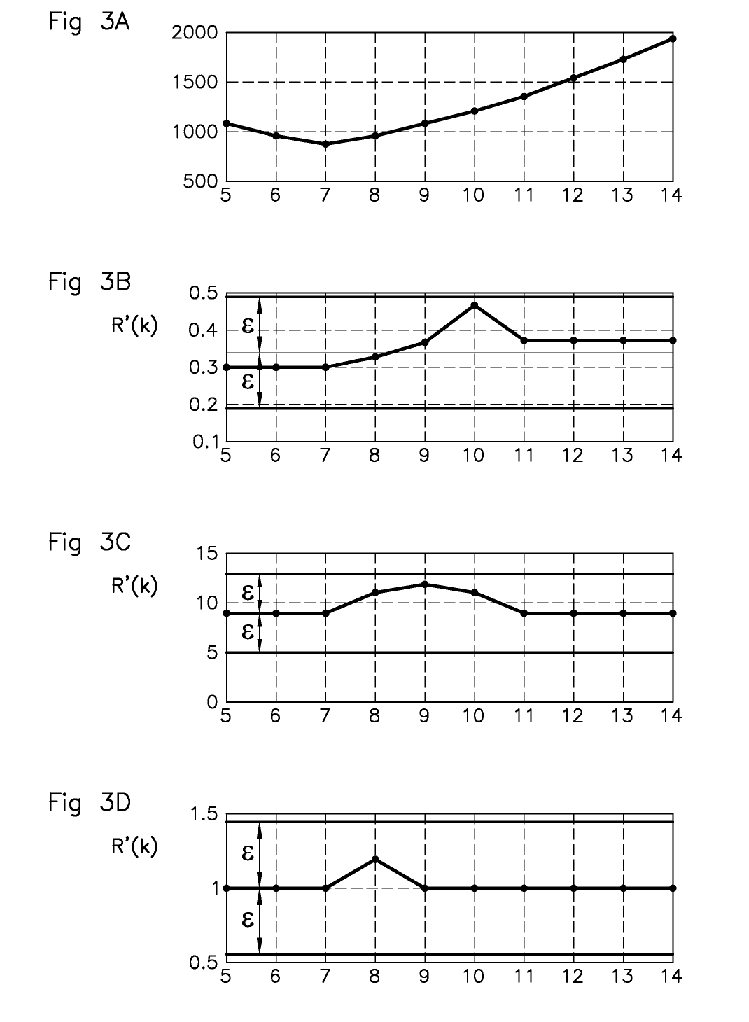

FIG. 3A is a curve illustrating a second profile of variation of the engine speed (in revs/minute) during the detection of teeth k;

FIG. 3B is a curve representing the value of the ratio R′(k) calculated for each of the teeth k in FIG. 3A when said teeth k are teeth of rank 1;

FIG. 3C is a curve representing the value of the ratio R′(k) calculated for each of the teeth k in FIG. 3A when said teeth k are teeth of rank 2; and

FIG. 3D is a curve representing the value of the ratio R′(k) calculated for each of the teeth k in FIG. 3A when said teeth k are teeth of rank higher than 3.

According to the invention, for a detected tooth k, the following ratio R′(k) is calculated:

$${R}^{′} ( k ) = [ \frac{{( T ( k - \frac{N}{2} ) )}^{N}}{{\prod }_{i}^{\frac{N}{2} + 1 … N} T ( k - i ) \times {\prod }_{i}^{0 … \frac{N}{2} - 1} T ( k - i )} ]$$

where N is an even integer greater than or equal to 2.

Based on this ratio R′(k), the rank r(k) of the tooth is deduced in the following manner:
if R′(k)=1±ε, then r(k) is in the range between N+2 and n;
if R′(k)=(m+1)^{N}±ε, then r(k)=p+1 with p such that N=2^{p}; and

$$if {R}^{′} ( k ) = \frac{1}{m + 1} \pm ɛ ,$$

then r(k) is in the range between 1 and p or between p+2 and N+1.

In these formulae, the integer N defines the order of the ratio R′(k). The higher this order N, the more robust is the determination of the rank r(k) of the tooth detected. These formulae notably depend on the order N and on the number of missing teeth (m). Furthermore, ε is a margin defining the amplitude of these intervals associated with the values 1, (m+1)^{N} and

$$\frac{1}{m + 1} .$$

These formulae are given hereinafter for various values of N and m:

Case 1) for N=2 and m=2

Given that

$${R}^{′} ( k ) = \frac{{T ( k - 1 )}^{2}}{T ( k - 2 ) \times T ( k )} ,$$

the rank r(k) of the tooth k is then:
if R′(k)=1±ε, r(k) is in the range between 4 and n;
if R′(k)=9±ε, r(k)=2 (case of R′(k) close to (m+1)^{N} and N=2^{p} which means p=1, and hence j=p+1=2); and
if

$${R}^{′} ( k ) = \frac{1}{3} \pm ɛ ,$$

r(k) is equal to 1 or 3 (case of R′(k) close to

$$\frac{1}{m + 1}$$

and N=2^{p} which means p=1, and hence jε[1,1]∪[3,3]).

Case 2) for N=2 and m=3

Given that

$${R}^{′} ( k ) = \frac{{T ( k - 1 )}^{2}}{T ( k - 2 ) \times T ( k )} ,$$

the rank r(k) of the tooth k is then:
if R′(k)=1±ε, r(k) is in the range between 4 and n;
if R′(k)=16±ε, r(k)=2 (case of R′(k) close to (m+1)^{N} and N=2^{p} which means p=1, and hence j=p+1=2); and
if

$${R}^{′} ( k ) = \frac{1}{4} \pm ɛ ,$$

r(k) is equal to 1 or 3 (case of R′(k) close to

$$\frac{1}{m + 1}$$

and N=2^{p} which means p=1, and hence jε[1,1]∪[3,3]).

Case 3) for N=4 and m=2

Given that

$${R}^{′} ( k ) = \frac{{T ( k - 2 )}^{4}}{T ( k - 4 ) \times T ( k - 3 ) \times T ( k - 1 ) \times T ( k )} ,$$

the rank r(k) of the tooth k is then:
if R′(k)=1±ε, r(k) is in the range between 6 and n;
if R′(k)=81±ε, r(k)=3 N=2^{p} (case of R′(k) close to (m+1)^{N} and N=2^{p} which means p=2, and hence j=p+1=3); and
if

$${R}^{′} ( k ) = \frac{1}{3} \pm ɛ ,$$

r(k) is equal to 1, 2, 4 or 5 (case of R′(k) close to

$$\frac{1}{m + 1}$$

and N=2^{p} which means p=2, and hence jε[1,2]∪[4,5]).

The advantages of the invention will more particularly be described by way of the case N=2 and m=2 (case 1). According to the invention, the determination of the rank (k) is very robust during the speed change phases of the engine. This robustness is illustrated hereinafter for two different time variation profiles of the engine speed illustrated in FIGS. 2A and 3A.

FIG. 2A shows a first engine speed profile comprising an acceleration phase followed by a deceleration phase. The engine speed increases substantially linearly between the detection of the tooth k=5 and the detection of the tooth k=7 then decreases between the detection of the tooth k=7 and the detection of the tooth k=14. In this figure, the engine speed profile is defined as a function of the detection of the teeth k.

Since the value of the ratio R′(k) is a function, not only of the engine speed, but also of the rank of the tooth k detected, 3 curves are shown (FIGS. 2B, 2C and 2D) representing the value of the ratio R′(k) for various ranks r(k).

FIG. 2B shows the value of the ratio R′(k) for an engine speed profile such as illustrated in FIG. 2A, by considering that the teeth k are successively teeth of rank 1. As can be seen in this figure, the ratio R′(k) varies around the value ⅓. When the engine speed increases, the ratio R′(k) is slightly higher than ⅓ and, when the engine speed decreases, the ratio R′(k) drops below ⅓. In the example in FIG. 2B, R′(k) remains in the range between 0.24 and 0.38. This curve is also valid for the teeth of rank 3.

FIG. 2C shows the value of the ratio R′(k) by considering that the teeth k detected are successively teeth of rank 2. As can be seen in this figure, the ratio R′(k) is always equal to 9 except when the speed begins to decrease after having risen beforehand (k=8, k=9 and k=10). In this case, the ratio R′(k) falls as low as 7 then recovers to 9.

FIG. 2D shows the value of the ratio R′(k) by considering that the teeth k detected are teeth of rank higher than 3. As can be seen in this figure, the ratio R′(k) is always equal to 1 except when the speed begins to decrease after having risen beforehand (k=8). In this case, the ratio R′(8) falls to about 0.8; it then returns to 1.

In FIGS. 3B to 3D, the values of the ratio R′ for an inverse profile of engine speed are shown.

FIG. 3A shows this inverse profile which comprises a deceleration phase followed by an acceleration phase. The engine speed decreases substantially linearly between the detection of the tooth k=5 and the detection of the tooth k=7, then increases between the detection of the tooth k=7 and the detection of the tooth k=14.

FIG. 3B shows the value of the ratio R′(k) for an engine speed profile such as illustrated in FIG. 3A by considering that the teeth k detected are successively teeth of rank 1. As can be seen in this figure, the ratio R′(k) varies around the value ⅓. When the engine speed decreases, the ratio R′(k) is slightly less than ⅓ and, when the engine speed increases, the ratio R′(k) increases and goes above ⅓. In the example in FIG. 3B, R′(k) remains in the range between around 0.3 and 0.46. This curve is also valid for the teeth of rank 3.

FIG. 3C shows the value of the ratio R′(k) by considering that the teeth k detected are successively teeth of rank 2. As can be seen in this figure, the ratio R′(k) is always equal to 9 except when the speed begins to increase after having decreased beforehand (k=8, k=9 and k=10). In this case, the ratio R′(k) increases up to about 12 then falls back to 9.

FIG. 3D shows the value of the ratio R′(k) by considering that the teeth k detected are teeth of rank higher than 3. As can be seen in this figure, the ratio R′(k) is always equal to 1 except when the speed begins to increase after having decreased beforehand (k=8). In this case, the ratio R′(8) increases to around 1.25; it subsequently returns to 1.

All these FIGS. 2A to 2D and 3A to 3D) show that the ratio R′ for a tooth of rank 1 (value of R′ in the range between 0.24 and 0.46) is different from that of a tooth of rank 2 (value of R′ in the range between 7 and 12) and from that of a tooth of higher rank (value of R′ in the range between 0.8 and 1.25). It is therefore very easy to discriminate these three classes of teeth (teeth of rank 1 or 3, teeth of rank 2, tooth of rank higher than 3).

Advantageously, with each of these classes of teeth is associated an interval of values R′. These intervals are defined around the reference values ⅓, 1 and 9, and do not overlap one another.

The following intervals of values R′(k) are for example defined:
[0.18-0.48] for the teeth of rank 1 or 3;
[4.95-13.05] for the teeth of rank 2;
[0.55-1.45] for the teeth of rank higher than 3.

These intervals have been defined by taking, on either side of each of the central values ⅓, 1 and 9, a margin c equal to 45% of the central value.

Thus, if the ratio R′(k) is contained within the interval [0.18-0.48], the tooth k is a tooth rank 1 or 3. If the ratio R′(k) is contained within the interval [4.95-13.05], the tooth k is a tooth rank 2. If the ratio R′(k) is contained within the interval [0.55-1.45], the tooth k is a tooth rank higher than 3.

Of course, these three intervals do not necessarily have to be centered on the values ⅓, 1 and 9. The margin c may also be different for each of the intervals. The following intervals could, for example, be defined:
[0.24-0.46] for the teeth of rank 1 or 3;
[7-12] for the teeth of rank 2;
[0.8-1.25] for the teeth of rank higher than 3.

As for the prior art, this method also allows it to be detected whether or not a tooth of the toothed target is missing. If

$${R}^{′} ( k ) \approx \frac{1}{2} ,$$

then R′(k+1)≈4 and

$${R}^{′} ( k + 2 ) \approx \frac{1}{2} ,$$

this means that the tooth of rank r(k) has not been detected. If R′=16, this means that the tooth of rank 1 has not been detected.

The invention also relates to the device implementing the method previously described and comprising means for calculating the first product and the second product, together with the ratio R′(k) between the first product and the second product, and means for determining information representative of the position of the tooth k with respect to the reference area, based on the ratio R′(k).

Although the invention has been described with reference to one particular embodiment, it goes without saying that it is not in any way limited to this and that it comprises all the techniques equivalent to the means described together with their combinations if the latter fall within the scope of the invention.

1. A method of determining information representative of the position of a real tooth of a toothed target rigidly attached in rotation to a shaft of an internal combustion engine, the toothed target comprising n real teeth and m missing teeth forming a reference area and said engine being equipped with a sensor for detecting the passage of the real teeth of the toothed target in front of said sensor and with a unit capable of measuring, for each tooth k, the period of time, called period (T(k)) of the tooth k, separating said tooth k from the preceding tooth k−1,
characterized in that it comprises the following steps:
a) a first product is calculated by multiplying N times the period
$$( T ( k - \frac{N}{2} ) )$$
of the tooth
$$k - \frac{N}{2} ,$$
N being an even integer greater than or equal to 2,
b) a second product is calculated by multiplying together the periods (T(k−i)) of the teeth i, with i in the range between 0 and
$$\frac{N}{2} - 1$$
and between
$$\frac{N}{2} + 1$$
and N,
c) the ratio between the first product and the second product, denoted R′(k), is calculated and
d) based on the ratio R′(k), an information representative of the position of the tooth k with respect to the reference area is determined.

2. The method as claimed in claim 1, characterized in that, at the step d), the information representative of the position of the tooth k is determined in the following manner:
if the ratio R′(k) is close to (m+1)^{N}, the tooth k is the tooth of rank j, with j=p+1 and p being such that N=2^{p};
if the ratio R′(k) is close to
$$\frac{1}{m + 1} ,$$
the tooth k is a tooth of rank j, with jε[1,p]∪[p+2,N+1]; and
if the ratio R′(k) is close to 1, the tooth k is a tooth of rank j, with jε[N+2, n].

3. The method as claimed in claim 1, characterized in that, with each of the values
$$\frac{1}{m + 1} ,$$
1 and (m+1)^{N}, is associated an interval encompassing said value, said intervals being non-mutually overlapping, and in that:
if the ratio R′(k) is included within the interval defined for the value (m+1)^{N}, then the tooth k is the tooth of rank j with j=p+1 and p being such that N=2^{p},
if the ratio R′(k) is included within the interval defined for the value
$$\frac{1}{m + 1} ,$$
then the tooth k is a tooth of rank j, with jε[1, p]∪[p+2, N+1],
if the ratio R′(k) is included within the interval defined for the value 1, then the tooth k is a tooth of rank j, with jε[N+2,n].

4. The method as claimed in claim 3, characterized in that said intervals are centered on the values
$$\frac{1}{m + 1} , 1$$
and (m+1)^{N}.

5. The method as claimed in claim 4, characterized in that said intervals centered on the values
$$\frac{1}{m + 1} ,$$
1 and (m+1)^{N} are:
[(1−ε)(m+1)², (1+ε)(m+1)²] for the value (m+1)²,
$$[ \frac{1 - ɛ}{m + 1} , \frac{1 + ɛ}{m + 1} ]$$
for the value
$$\frac{1}{m + 1} ,$$
and
[1−ε,1+ε] for the value 1,
with ε in the range between 0.01 and 0.5.

6. A device implementing the method as claimed in claim 1, characterized in that it comprises means for calculating the first product and the second product, together with the ratio R′(k) between the first product and the second product and means for determining information representative of the position of the tooth k with respect to the reference area based on the ratio R′(k).

7. The method as claimed in claim 2, characterized in that, with each of the values
$$\frac{1}{m + 1} ,$$
1 and (m+1)^{N}, is associated an interval encompassing said value, said intervals being non-mutually overlapping, and in that:
if the ratio R′(k) is included within the interval defined for the value (m+1)^{N}, then the tooth k is the tooth of rank j with j=p+1 and p being such that N=2^{p},
if the ratio R′(k) is included within the interval defined for the value
$$\frac{1}{m + 1} ,$$
then the tooth k is a tooth of rank j, with jε[1, p]∪[p+2, N+1],
if the ratio R′(k) is included within the interval defined for the value 1, then the tooth k is a tooth of rank j, with jε[N+2,n].

8. The method as claimed in claim 7, characterized in that said intervals are centered on the values
$$\frac{1}{m + 1} ,$$
1 and (m+1)^{N}.

9. The method as claimed in claim 8, characterized in that said intervals centered on the values
$$\frac{1}{m + 1} , 1$$
and (m+1)^{N} are:
[(1−ε)(m+1)², (1+ε)(m+1)²] for the value (m+1)²,
$$[ \frac{1 - ɛ}{m + 1} , \frac{1 + ɛ}{m + 1} ]$$
for the value
$$\frac{1}{m + 1} ,$$
and
[1−ε,1+ε] for the value 1,
with ε in the range between 0.01 and 0.5.
